(19) United States
(12) Patent Application Publication
(10) Pub. No.: US 2009/0168725 A1
(43) Pub. Date: Jul. 2, 2009

(54) COMMUNICATION HANDOVER MANAGEMENT

(75) Inventor: Anjali Mishra, Encinitas, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/341,611

(22) Filed: Dec. 22, 2008

Related U.S. Application Data
(60) Provisional application No. 61/016,759, filed on Dec. 26, 2007.

(51) Int. Cl. H04W 36/00

(52) U.S. Cl. 370/331

(57) ABSTRACT

As a communication is engaged upon a mobile device, data can be relayed through a base station. Determining which base station the mobile device should use can be based upon location and velocity of the mobile device. Other factors can be taken into account in determining a base station, such as power output of the mobile device and base station, load balancing, mobile device trends, and the like. Based upon these various factors, a determination can be made if the mobile device should transfer base stations.

### CROSS-REFERENCE

This application claims priority to U.S. Provisional Application No. 61/016,759 entitled “Location Assisted Handoff in LTE”, which was filed on Dec. 26, 2007. The entirety of which is herein incorporated by reference.

### BACKGROUND

1. Field

The following description relates generally to wireless communications and, more particularly, to managing communication handover, commonly in conjunction with a mobile device.

2. Background

Wireless communication systems are widely deployed to provide various types of communication content such as, for example, voice, data, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth.

MIMO systems commonly employ multiple (NT) transmit antennas and multiple (NR) receive antennas for data transmission. A MIMO channel formed by the NT transmit and NR receive antennas can be decomposed into NS independent channels, which can be referred to as spatial channels. Each of the NS independent channels corresponds to a dimension. Moreover, MIMO systems can provide improved performance (e.g., increased spectral efficiency, higher throughput and/or greater reliability) if the additional dimensionalities created by the multiple transmit and received antennas are utilized.

MIMO systems can support various duplexing techniques to divide forward and reverse link communications over a common physical medium. For instance, frequency division duplex (FDD) systems can utilize disparate frequency regions for forward and reverse link communications. Further, in time division duplex (TDD) systems, forward and reverse link communications can employ a common frequency region. However, conventional techniques can provide limited or no feedback related to channel information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one aspect, there is a method operable upon a wireless communication device for managing handover of a communication. The method can include identifying metadata relevant to association of a mobile device with a cell of a base station. Moreover, the method can also include transmitting at least a portion of the identified metadata that is relevant toward determining if a handover should occur, identification or transmission occurs upon the wireless communication device.

In accordance with an additional aspect, there can be an apparatus that includes an identifier that identifies metadata relevant to association of a mobile device with a cell of a base station. The apparatus can also include a transmitter that produces at least a portion of the identified metadata that is relevant toward determining if a handover should occur.

With another aspect, there can be at least one processor configured to manage handover of a communication. The processor can include a first module for identifying metadata relevant to association of a mobile device with a cell of a base station. In addition, the processor can include a second module for transmitting at least a portion of the identified metadata that is relevant toward determining if a handover should occur.

In view of a further aspect, there can be a computer program product with a computer-readable medium. The medium can include a first set of codes for causing a computer to identify metadata relevant to association of a mobile device with a cell of a base station. The medium can also include a second set of codes for causing the computer to transmit at least a portion of the identified metadata that is relevant toward determining if a handover should occur.

Through yet another aspect, there can be an apparatus with means for identifying metadata relevant to association of a mobile device with a cell of a base station. The apparatus can additionally include means for transmitting at least a portion of the identified metadata that is relevant toward determining if a handover should occur.

According to one aspect, there can be a method operable upon a wireless communication device for determining handover of a communication. The method can include evaluating positioning metadata related to a mobile device. The method can also include determining if the mobile device should transfer from a servicing base station to a neighboring base station, the determination is based at least in part upon a result of the evaluation and the evaluation or determination is performed by the wireless communication device.

In accordance with an additional aspect, there can be an apparatus with an analyzer that evaluates positioning metadata related to a mobile device. The apparatus can also include a verifier that determines if the mobile device should transfer from a servicing base station to a neighboring base station, the determination is based at least in part upon a result of the evaluation.

With another aspect, there can be at least one processor configured to determine handover of a communication that includes a first module for evaluating positioning metadata related to a mobile device. The processor can also include a second module for determining if the mobile device should transfer from a servicing base station to a neighboring base station, the determination is based at least in part upon a result of the evaluation.

In view of a further aspect, there can be a computer program product with a computer-readable medium. The medium can include a first set of codes for causing a computer to evaluate positioning metadata related to a mobile device. The medium can also include a second set of codes for causing the computer to determine if the mobile device should transfer from a servicing base station to a neighboring base station, the determination is based at least in part upon a result of the evaluation.

Through yet another aspect, there can be an apparatus with means for evaluating positioning metadata related to a mobile device. The apparatus can also include means for determining if the mobile device should transfer from a servicing base station to a neighboring base station, the determination is based at least in part upon a result of the evaluation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of a representative system for managing communication handover in accordance with at least one aspect disclosed herein.

FIG. 3 is an illustration of a representative system for managing communication handover with a detailed mobile device in accordance with at least one aspect disclosed herein.

FIG. 4 is an illustration of a representative system for managing handover transfer regarding information freshness level in accordance with at least one aspect disclosed herein.

FIG. 5 is an illustration of a representative system for managing handover transfer with engagement capabilities in accordance with at least one aspect disclosed herein.

FIG. 6 is an illustration of a representative system for managing handover transfer with observation capabilities in accordance with at least one aspect disclosed herein.

FIG. 7 is an illustration of a representative system for managing handover transfer with operation performed by a base station in accordance with at least one aspect disclosed herein.

FIG. 8 is an illustration of a representative metadata transfer methodology related to handover of a communication in accordance with at least one aspect disclosed herein.

FIG. 9 is an illustration of a representative power management methodology regarding communication handover in accordance with at least one aspect disclosed herein.

FIG. 10 is an illustration of a representative methodology for determining if a handover should occur for a communication in accordance with at least one aspect disclosed herein.

FIG. 11 is an illustration of an example mobile device that facilitates information transfer regarding handover of a communication in accordance with at least one aspect disclosed herein.

FIG. 12 is an illustration of an example system that facilitates determination of communication handover in accordance with at least one aspect disclosed herein.

FIG. 13 is an illustration of an example wireless network environment that can be employed in conjunction with the various systems and methods described herein.

FIG. 14 is an illustration of an example system that in accordance with at least one aspect disclosed herein.

FIG. 15 is an illustration of an example system that in accordance with at least one aspect disclosed herein.

### DETAILED DESCRIPTION

The techniques described herein can be used for various wireless communication systems such as Code Division Multiple Access (CDMA), Time division multiple access (TDMA), Frequency Division Multiple Access (FDMA), Orthogonal Frequency-Division Multiple Access (OFDMA), Single Carrier FDMA (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers Interim Standard (IS)-2000, IS-95 and IS-856 standards. A TDMA system can implement a radio technology such as Global System for Mobile Communications (GSM). An OFDMA system can implement a radio technology such as Evolved Universal Terrestrial Radio Access (Evolved UTRA or E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDM®, etc. Universal Terrestrial Radio Access (UTRA) and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects are now described with reference to the drawings, wherein like reference numerals are used to refer to like elements throughout. In the following description, for purposes of explanation, numerous specific details are set forth in order to provide a thorough understanding of one or more aspects. It can be evident, however, that such aspect(s) can be practiced without these specific details. In other instances, well-known structures and devices are shown in block diagram form in order to facilitate describing one or more embodiments.

As used in this application, the terms “component,” “module,” “system” and the like are intended to include a computer-related entity, such as but not limited to hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station can be utilized for communicating with wireless terminal(s) and can also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

Various aspects or features will be presented in terms of systems that can include a number of devices, components, modules, and the like. It is to be understood and appreciated that the various systems can include additional devices, components, modules, etc. and/or can include all of the devices, components, modules etc. discussed in connection with the figures. A combination of these approaches can also be used.

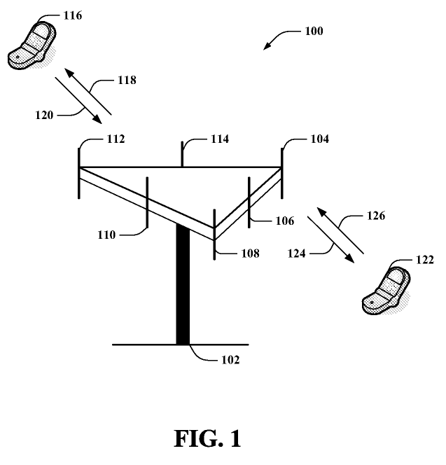

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

The set of antennas and/or the area in which they are designated to communicate can be referred to as a sector of base station 102. For example, multiple antennas can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices.

With aspects disclosed herein, the mobile device 116 or 122 can report its location and/or velocity with handover request messages. This can allow the base station 102 to make handover decision based on location, velocity, power level, etc. reported by the mobile device 116 or 122. This location assisted handover (LAHO) can allow for faster and more reliable handover. It could be faster since there can be reduced dependency on handover timers used in classical handover techniques.

The mobile device 116 or 122 could report its location and velocity with handover message—for example, if the mobile device 116 or 122 calculates this on demand or in regular scheduled fashion. This could be achieved by using standard mobile based location technologies for either network assisted location technologies, or satellite assisted location technologies, as well as other.

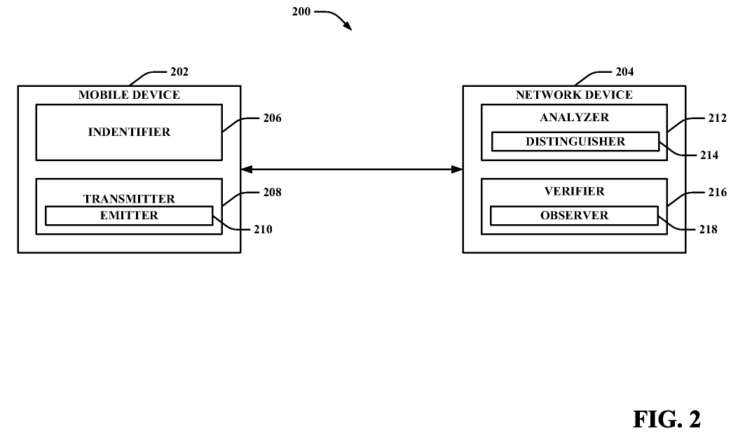

Now referring to FIG. 2, an example system 200 is disclosed for managing a base station cell that is used by a mobile device 202. In a conventional wireless communication scheme, multiple base stations are spread throughout a network. As a user travels throughout the network, the mobile device 202 can transfer to an appropriate base station to use for a communication. In accordance with aspects disclosed herein, metadata (e.g., information, details, available to mobile device 202, available to base station, can be evaluated in real-time, local on the mobile device 202, located on the network device 204, etc.) pertaining to the mobile device 202 can be used in determining a base station to use, including location and/or velocity metadata. The mobile device 202 can engage with a network device 204 (e.g., base station, central server, etc.) to facilitate communication.

The mobile device 202 can include an identifier 206 that identifies metadata (e.g., mobile device location, mobile device velocity, power output, signal strength, signal-to-interference ration, channel interference, power threshold, timer values, information derived from other information, etc.) relevant to association of the mobile device 202 with a cell of a base station. For example, the mobile device 202 can periodically make note of a location and velocity and transfer metadata (e.g., the location, velocity, time, etc.) to a base station. The identifier 206 can identify the noted location and velocity in storage and determine if the metadata is relevant.

A transmitter 208 can be used that outputs at least a portion of the identified metadata (e.g., outputs to a base station). In an illustrative example, the transmitter 208 can configure as an antenna and amplifier configuration. According to one embodiment, the transmitter 208 uses an emitter 210 that transfers at least a portion of the identified metadata to the base station.

While the mobile device 202 can supply metadata, the network device 204 can use the metadata to determine if a handover should occur. A handover can be a transfer of a communication of the mobile device 202 from a cell of one base station to another. An analyzer 212 can be employed that evaluates positioning metadata related to the mobile device 202 (e.g., metadata revealing a physical location of the mobile device, revealing a location relative to a base station, etc.). The positioning metadata can be based on an actual (e.g., known) position as well as on an estimated position.

In one example, the analyzer 212 can use a distinguisher 214 that compares metadata obtained at different instances. If a location progresses further and further away from a base station, then this can be an indication that the mobile device 202 should be transferred to another cell (e.g. a cell closest to a current location). A verifier 216 can be used that determines if the mobile device 202 should transfer from a servicing base station to a neighboring base station, the determination is based at least in part upon a result of the evaluation (e.g., based upon the positioning metadata or information derived there-from). For example, the determination can be made based upon a location of the mobile device 202, a velocity of the mobile device 202, load balancing of a network, etc. While the mobile device 202 could have lowered signal strength and this can be indicative the mobile device is travelling further away, it is possible that other factors other than movement impact the signal strength, such as increased interference. Thus, a determination can be made on if lower signal strength is indicative of travel and the determination (e.g., information derived from positioning metadata) can be used in resolving if a transfer should occur. In one implementation, an observer 218 can be used by the verifier 216 that resolves if there is a high enough deviation in metadata from the different instances to warrant the transfer (e.g., through a result produced by the distinguisher 214). The network device 204 can include an transmitter (e.g., part of the verifier 216) that notifies another network device (e.g., another base station) to take a communication—thus, as opposed to sending the call to another base station, a request is made for another base station to extract the call.

Different considerations can be taken into account when determining if a handover should occur. For example, a mobile device 202 can expend a relatively large amount of energy transferring the metadata, which can be indicative that the mobile device 202 is too far away from a base station and thus a handover should occur. However, there can be other considerations taken into account—for instance, if other nearby base stations have a heavy load of calls, then handover does not occur and the mobile device 202 continues to operate in a less then optimum manner.

When a handover occurs, the handover can be associated with a triggering event (e.g., a triggering event occurs for each handover). The triggering event can include a determination that the signal-to-noise ratio, co-channel interference, adjacent channel interference of the mobile device 202 exceeds a threshold while the mobile device 202 is within the coverage area of a serving cell and signal strength from the serving cell is of high enough quality to trigger handover. The mobile device 202 could make the aforementioned determination or the network device 204 can collect metadata (e.g., from the mobile device 202) and make the determination. For example, co-channel interference can be relatively high for a relatively long time while the mobile device 202 can function in two different cells. Since the interference is high, there can be a check to determine if the mobile device should switch to another cell (e.g., there is less likelihood of co-channel interference on the cell).

There can also be use of a timer to monitor a signal-to-noise ratio, co-channel interference, adjacent channel interference of a subscriber station, the monitoring determines if interference exceeds a threshold for more than duration set in the timer-blocking spurious rise in noise floor or interference level can occur that thus encouraging handover. There can be a thermal heating on a mobile device or base station and the thermal heating can cause interference. High thermal heating can indicate that the power is high and handover should occur; likewise, an algorithm can be run to minimize high thermal heating.

Practices of aspects disclosed herein can be used to minimize impact of cell dragging. With cell dragging, due to various factors (e.g., weather, obstructions, etc.) a signal can propagate in a way that it reaches beyond a zone the signal is intended to reach (e.g., into a adjacent cell). This can confuse a distant base station (e.g., base station of the adjacent cell) and thus impact operation—thus, the distant base station can communicate the situation to a relevant mobile device. Moreover, the mobile device 202 or network device 204 can use a scheduler (e.g., optimized scheduler) that plans events and assists in handover decisions.

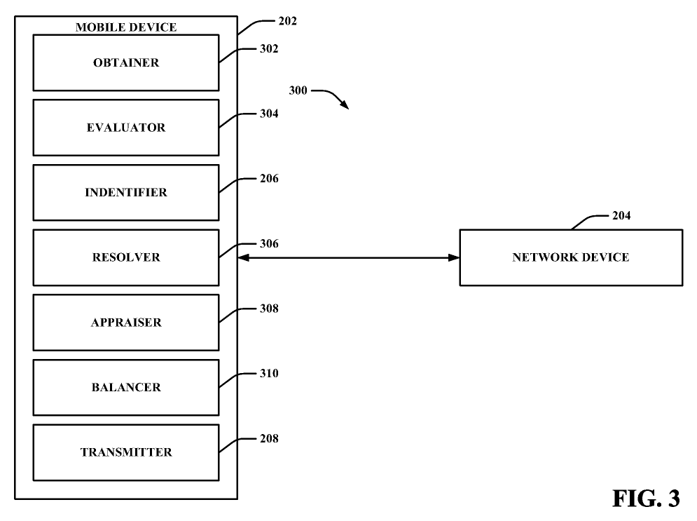

Now referring to FIG. 3, an example system 300 is disclosed for providing metadata to a base station (such as a network device 204) that can be used in making a handover decision (e.g., a decisions on if a handover should occur). An obtainer 302 can be used that that collects a request for metadata, metadata identification occurs in accordance with the request. For example, the base station can send a request to all mobile devices within a cell asking for positioning metadata; the base station can used the metadata to determine if there should be a handover (e.g., transfer calls closest to a cell edge). The request can be collected by the obtainer, verified (e.g., determining that the base station has permission to obtain metadata), and analyzed (e.g., to determine metadata desired by the base station).

The mobile device 202 can use an evaluator 304 that determines the location of the mobile device. The determination can be made by employing a global positioning system, inertial navigation system, etc. The evaluator 304 can also be used to make other determinations related to mobile device operation, such as velocity, orientation, etc. The identifier 206 identifies (e.g., is made aware of, locates, etc.) metadata relevant to association of a mobile device with a cell of a base station. For example, determinations made by the evaluator 304 can be analyzed by the identifier 206 and a determination can be made on which metadata is relevant.

It is to be appreciated that artificial intelligence techniques can be used to practice determinations and inferences disclosed herein. These techniques employ one of numerous methodologies for learning from data and then drawing inferences and/or making determinations related to dynamically storing information across multiple storage units (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. These techniques can also include methods for capture of logical relationships such as theorem provers or more heuristic rule-based expert systems. These techniques can be represented as an externally pluggable module, in some cases designed by a disparate (third) party. A changer 406 can transfer the mobile device 202 to the new cell and/or revert operation to a previous frequency.

It is possible that power usage is an indicator that a handover should take place (e.g., power consumption being indicative that the mobile device 202 is too far from the base station). A resolver 306 can be employed that determines what power level is to be considered too high and then sets the high level. An appraiser 308 can be used that measures a power output of the mobile device.

The mobile device 202 can employ a balancer 310 that determines if the power output is at a high level (e.g., high enough to warrant a transfer, high enough to warrant consideration of a transfer, etc.). According to one embodiment, upon determining that the output is at the high level metadata identification occurs. However, high power level can also be a portion of metadata disclosed to a base station; this can be done at request of the base station, independent of the base station request, without request, etc. Moreover, a transmitter 208 can output at least a portion of the identified metadata; in one implementation the transmitter 208 operates at periodic times. However, other embodiments can be practiced, such as random operation and output, at request of a base station, etc.

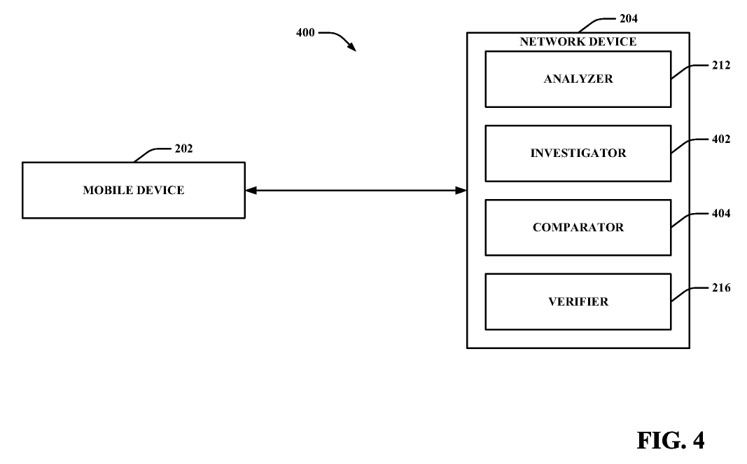

Referring now to FIG. 4, an example system 400 is disclosed for processing metadata to determine if a communication handover should occur. A mobile device 202 can engage with a network device 204 (e.g., base station). Metadata pertaining to operation of a mobile device 202 can be collected and evaluated by an analyzer 212. The analyzer 212 can identify from which mobile device the metadata originates and interpret the metadata—for instance the analyzer 212 can identify a location of the mobile device 202 in relation to other base stations.

Various delays can occur in relation to transferring metadata (e.g., positioning metadata). Therefore, it is possible that metadata is not fresh enough such that the information is too old to be considered accurate. For example, if several metadata groups show a mobile device is moving quickly (e.g., located in an automobile) and another group arrives delayed, then there can be an inference drawn that the mobile device 202 has moved and the metadata is no longer accurate. An investigator 402 can be used that calculates a freshness level of the positioning metadata (e.g., evaluates a timestamp associated with the metadata).

The network device 204 can use a comparator 404 that establishes if the freshness level is high enough to be relied upon for determining if there should be a mobile device transfer. The freshness level can be a varying standard based upon a variety of factors, including freshness of other metadata, likelihood of a communication being lost (e.g., if there is high risk of losing a communication, then the level can be low), etc. In an alternative embodiment, if information is considered too old, then other actions can occur. With an illustrative instance, a request can be made for a metadata update, the metadata can be used with less emphasis (e.g., other factors are given more weight, such as interference), life of the information can be extended (e.g., through use of an algorithm), etc. A verifier 216 can be used to determine if a handover should take place, the determination is based at least in part upon positioning information (e.g., location, velocity, orientation, etc.).

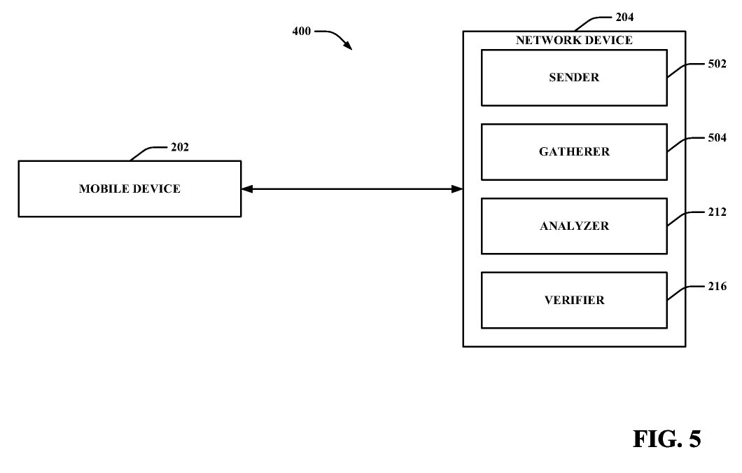

Now referring to FIG. 5, an example system 500 is disclosed for engaging with a mobile device 202 to collect metadata that can be processed by a network device 204 to determine if a handover should take place. If a base station carries too heavy of a load (e.g., a load that is beyond what is considered optimal), then a decision can be made that a call handover should be considered. A sender 502 can be used that transfers a request for the positioning metadata from the network device 204 to the mobile device 202. Since it can consume a large number of resources to evaluate metadata, the sender 502 can select at least one mobile device that should receive a request while not sending a request to others. Moreover, requests can be sent in a staggered manner to relieve processing load on the network device 204.

Based upon the request and/or through initiation of the mobile device 202, a gatherer 504 can collect the positioning metadata. The metadata can be processed to identify from which mobile device the metadata originates (e.g., reading a number of bits on a packet with identification information). An analyzer 212 and a verifier 216 can operate to evaluate the metadata and determine if a handover should occur. If appropriate (e.g., based upon a positive determination), then the verifier can instigate the handover (e.g., perform the handover, instruct the mobile device 202 to change base station cells, and the like).

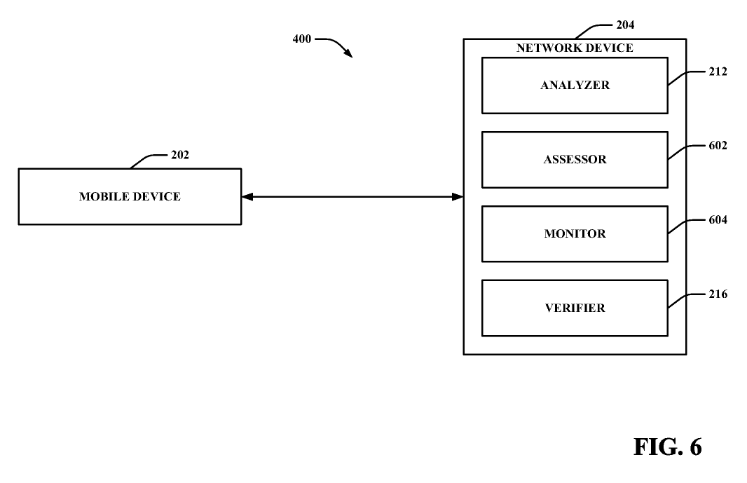

Now referring to FIG. 6, an example system 600 is disclosed for evaluating a network in association with handing over a communication from one base station to another. Various positioning metadata of at least one mobile device 202 can be evaluated by an analyzer 212 at a network device 204. However, in addition to metadata of the mobile device 202, other considerations can be taken into account for determining if there should be a handover transfer.

For example, a monitor 602 (e.g., monitoring module) can be used that calculates the base station load balancing (e.g., number of calls handled by a cell). Moreover, load balancing across a network which the base station associates can be calculated. Power consumption of the base station can be considered important in making a handover decision and therefore an assessor 604 can be used that measures a power output of the base station. For instance, high power output to communicate with the mobile device 202 can be indicative that the mobile device 202 is physically far away and therefore a handover transfer should occur.

A verifier 216 can taken into account the positioning metadata, base station load balancing, power output of the base station, and other factors in determining if a handover should take place. Additionally, the verifier 216 can operate to determine if handovers of multiple communications should occur. For example, to evenly distributed load balancing, multiple communication can be handed over (e.g., as a function of position for the mobile devices).

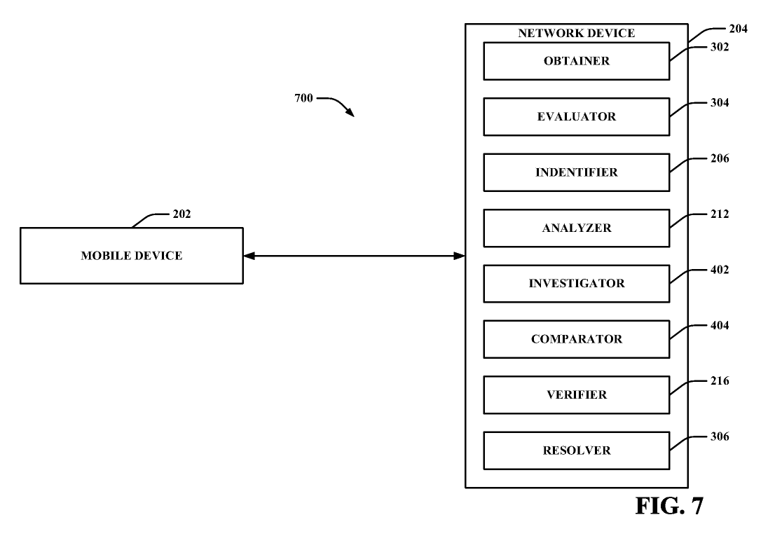

Referring now to FIG. 7, a detailed network device 204 (e.g., base station) is disclosed that communicates with a mobile device 202. Aspects disclosed as functioning upon the mobile device 202 can be practiced upon the network device 204 and vice versa. An obtainer 302 can collect a request for metadata (e.g., originating from the mobile device 202) and an evaluator 304 can determine a location of the mobile device 202. For instance, through interaction with the mobile device 202 in providing communication services, the network device can determine or infer a location of the mobile device 202 (e.g., by timing how long it takes to receive a response for an information request).

The identifier 206 can identify relevant information (e.g., positioning information) and an analyzer can evaluate the information. The network device 204 can determine a recentness characteristic of the relevant information through use of an investigator 402 and a comparator 404 can determine if the information is recent enough for use. A verifier 216 can determine if the mobile device 202 should transfer base stations (e.g., based upon a result of an output of the analyzer 212) and a resolver 306 can set a standard for the comparator 404 to use in determining if the information is recent enough for use.

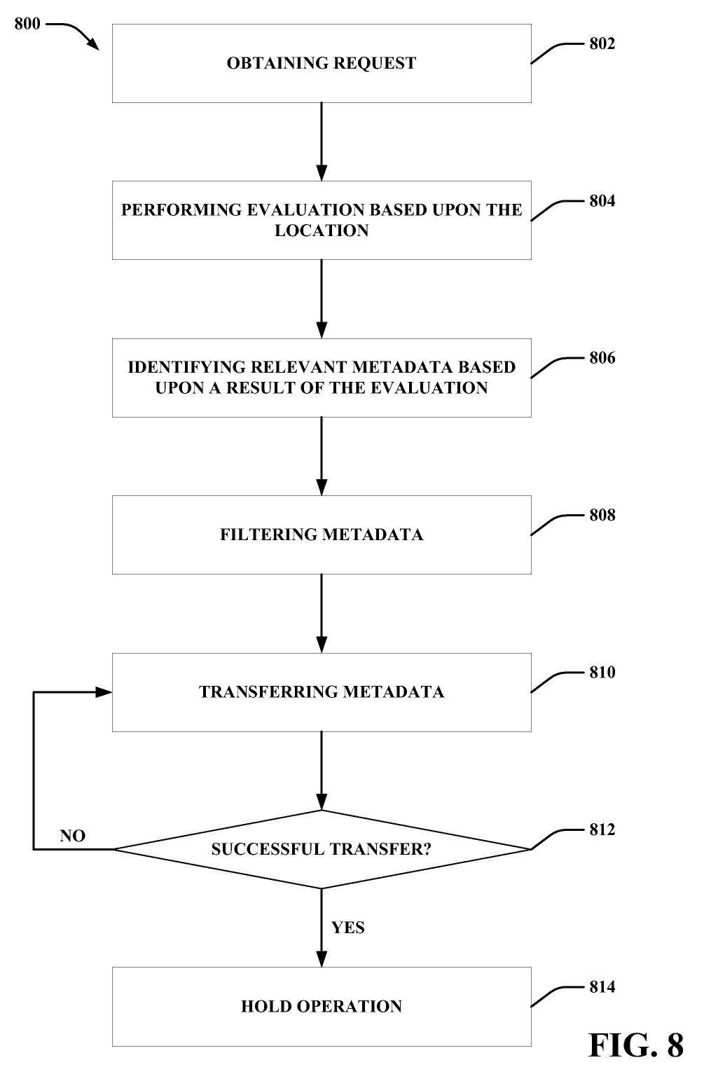

Now referring to FIG. 8, an example methodology 800 is disclosed for communicating metadata pertinent to a determination if a communication handover should take place. A request to provide positioning metadata can be collected at event 802, such as the request originating from a central management location. In another embodiment, a determination that metadata should be provided can originate from the mobile device, such as through evaluation of characteristics. For example, if the mobile device is expending a relatively high amount of power, then a determination can be made that positioning metadata should be transferred with an appeal to experience a handover.

An evaluation can be performed at act 804 to determine the position of the mobile device—this can be facilitated by the request (e.g., take place upon understanding the request) or take place automatically (e.g., the mobile device continuously monitors positioning). Based upon the request, relevant metadata can be identified at action 806. For instance, the evaluation can produce location, orientation, and velocity information. The request can be evaluated and only request location and therefore identification of the location information occurs.

There can also be filtering of metadata that occurs through action 808—for example, location information can be relatively private and therefore while location can be disclosed, velocity can be held back. At least a portion of the identified metadata can be transferred through event 810. A check 812 can take place to determine if the metadata transfer is successful. If the transfer is not successful, then the methodology 800 can return to event 810 to attempt to re-transfer. According to one embodiment, after a specific number of unsuccessful transfer attempts, transferring can stop and/or an error message can be generated. If the transfer is successful, then the methodology 800 can hold operation at action 814 until another request is obtained.

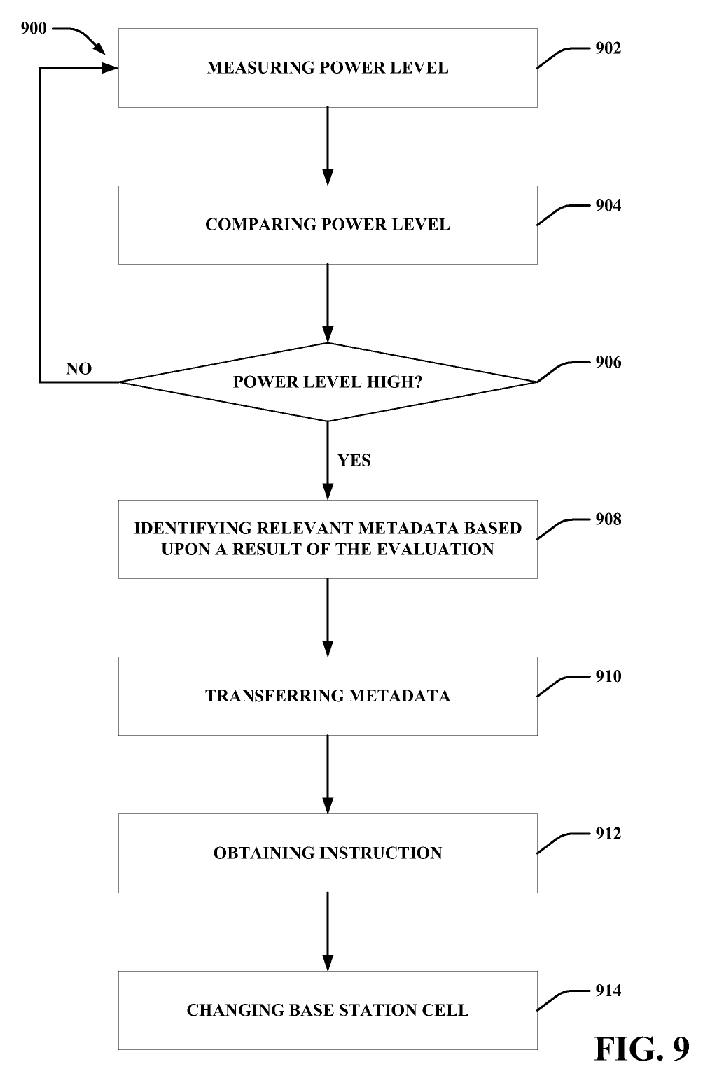

Now referring to FIG. 9, an example methodology 900 is disclosed for transferring power level information to a base station. A power level of a mobile device can be measured at action 902—this can include overall power level of the mobile device as well as power level use in communication with a base station. The power level measured can be compared against a power level standard at act 904.

A check 906 can be run to determine if the power level is too high (e.g., high enough to warrant a handover). If it is determined that the power level is not too high, then the methodology 900 can return to action 902 and a continuous loop can operate determining if a power level is too high. If it is determined that the power level is too high, then the power level can be identified as metadata relevant in communication handover through act 908.

The metadata can be transferred to at least one base station through action 910. The mobile device can participate in transferring base station cells—at event 912 an instruction can be collected that the base station should be switched. The instruction can include a base station that the mobile device should switch to as well as a rationale for switching. Based upon the instruction, the mobile device can switch base station cells at act 914.

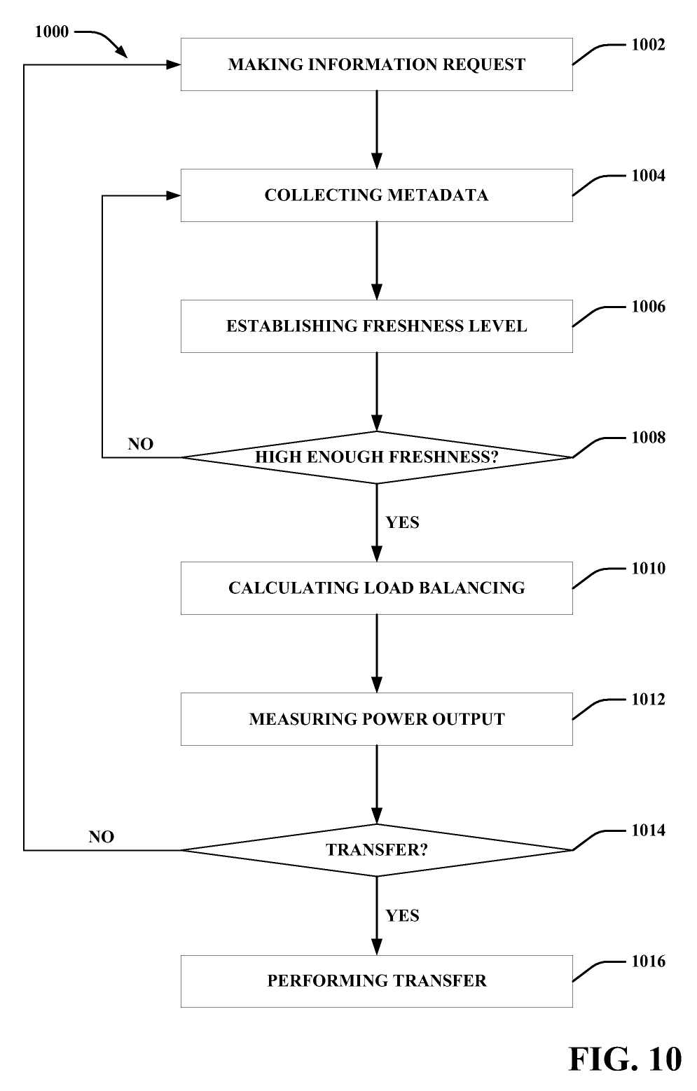

Referring now to FIG. 10, an example methodology 1000 is disclosed for determining if a handover should occur for a mobile device communication. The base station can make a request for positioning metadata at event 1002 and/or positioning metadata can be automatically transferred from a mobile device. The metadata can be collected through event 1004, which can include passive collection (e.g., receiving metadata from the mobile device) and active collection (e.g., extracting metadata from the mobile device).

At event 1006, a freshness level of the metadata can be established to determine how recent the information is and thus determine a reliability level of the information. A check 1008 can be used to determine if the metadata is fresh enough to be used. If the check makes a negative determination, then the methodology 1000 can again collect metadata in an attempt to obtain fresher information at event 1004. It is to be appreciated that the manner of collection can be changed (e.g., from passive to active) upon iteration of event 1004.

Load balancing of a network of the base station can be calculated at event 1010 and a power output of the base station and/or mobile device can be determined at action 1012. Based upon positioning metadata, power output, load balancing, a combination thereof, or other factors can be used by check 1014 to determine if a handover should take place. If it is determination that a handover should occur, then the handover can be implemented at event 1016. If transfer should not occur, then the methodology 1000 can return to event 1002 to make another request for metadata and the methodology 1000 can function again.

Referring to FIGS. 8-10, methodologies relating to determining if a handover of a communication should occur. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

It will be appreciated that, in accordance with one or more aspects described herein, inferences can be made regarding whether a handover should occur, if information should be used in making a determination, etc. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. It will be appreciated that the foregoing examples are illustrative in nature and are not intended to limit the number of inferences that can be made or the manner in which such inferences are made in conjunction with the various embodiments and/or methods described herein.

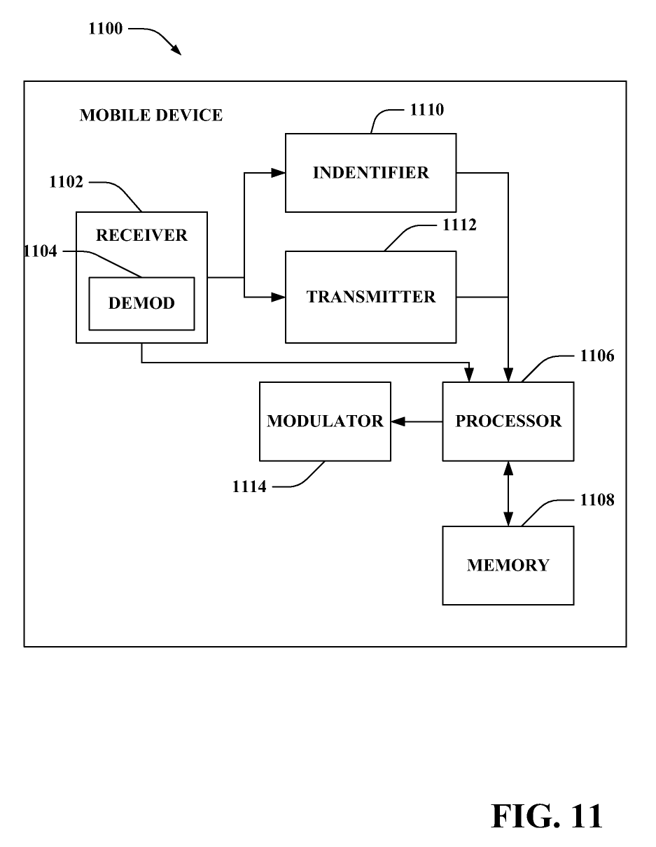

FIG. 11 is an illustration of a mobile device 1100 that facilitates employing management of communication handover. Mobile device 1100 comprises a receiver 1102 that receives a signal from, for instance, a receive antenna (not shown), and performs typical actions thereon (e.g., filters, amplifies, downconverts, etc.) the received signal and digitizes the conditioned signal to obtain samples. Receiver 1102 can be, for example, an MMSE receiver, and can comprise a demodulator 1104 that can demodulate received symbols and provide them to a processor 1106 for channel estimation. Processor 1106 can be a processor dedicated to analyzing information received by receiver 1102 and/or generating information for transmission by a transmitter 1116, a processor that controls one or more components of mobile device 1100, and/or a processor that both analyzes information received by receiver 1102, generates information for transmission by transmitter 1116, and controls one or more components of mobile device 1100.

Mobile device 1100 can additionally comprise memory 1108 that is operatively coupled to processor 1106 and that can store data to be transmitted, received data, information related to available channels, data associated with analyzed signal and/or interference strength, information related to an assigned channel, power, rate, or the like, and any other suitable information for estimating a channel and communicating via the channel. Memory 1108 can additionally store protocols and/or algorithms associated with estimating and/or utilizing a channel (e.g., performance based, capacity based, etc.).

It will be appreciated that the data store (e.g., memory 1108) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1108 of the subject systems and methods is intended to comprise, without being limited to, these and any other suitable types of memory.

Processor 1102 is further operatively coupled to an identifier 1110 that identifies metadata relevant to association of a mobile device with a cell of a base station and/or a transmitter 1112 that outputs at least a portion of the identified metadata. Mobile device 1100 still further comprises a modulator 1114 and a transmitter 1116 that transmits a signal (e.g., base CQI and differential CQI) to, for instance, a base station, another mobile device, etc. Although depicted as being separate from the processor 1106, it is to be appreciated that the identifier 1110 and/or transmitter 1112 can be part of processor 1106 or a number of processors (not shown).

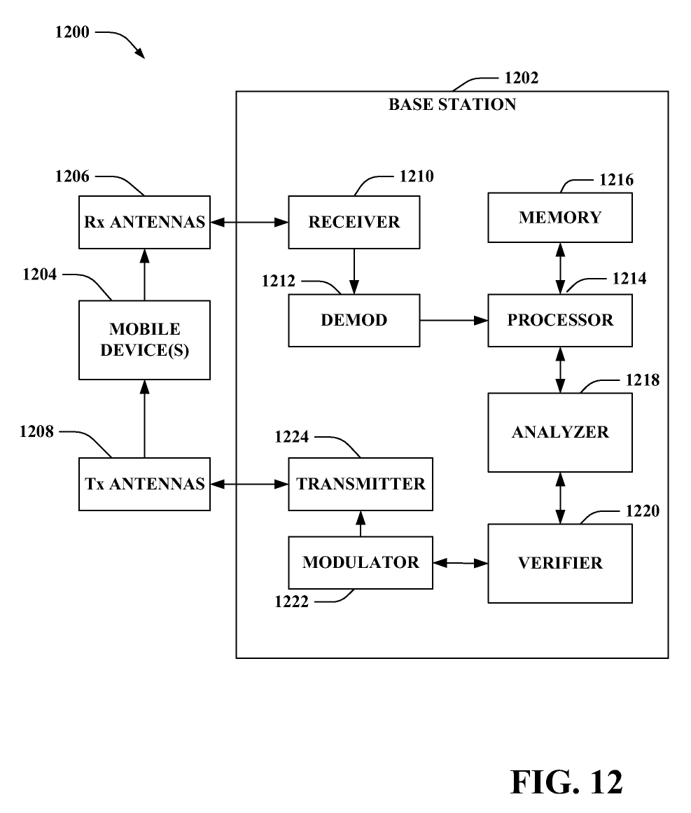

FIG. 12 is an illustration of a system 1200 that facilitates transferring of a communication. System 1200 comprises a base station 1202 (e.g., access point, . . . ) with a receiver 1210 that receives signal(s) from one or more mobile devices 1204 through a plurality of receive antennas 1206, and a transmitter 1222 that transmits to the one or more mobile devices 1204 through a plurality of transmit antennas 1208. Receiver 1210 can receive information from receive antennas 1206 and is operatively associated with a demodulator 1212 that demodulates received information. Demodulated symbols are analyzed by a processor 1214 that can be similar to the processor described above with regard to FIG. 11, and which is coupled to a memory 1216 that stores information related to estimating a signal (e.g., pilot) strength and/or interference strength, data to be transmitted to or received from mobile device(s) 1204 (or a disparate base station (not shown)), and/or any other suitable information related to performing the various actions and functions set forth herein.

Processor 1214 is further coupled to an analyzer 1218 that evaluates positioning metadata related to a mobile device and/or a verifier 1220 that determines if the mobile device should transfer from a servicing base station to a neighboring base station, the determination is based at least in part upon a result of the evaluation. Information to be transmitted can be provided to a modulator 1222. Modulator 1222 can multiplex the information for transmission by a transmitter 1224 through antenna 1208 to mobile device(s) 1204. Although depicted as being separate from the processor 1214, it is to be appreciated that the analyzer 1218 and/or verifier 1220 can be part of processor 1214 or a number of processors (not shown).

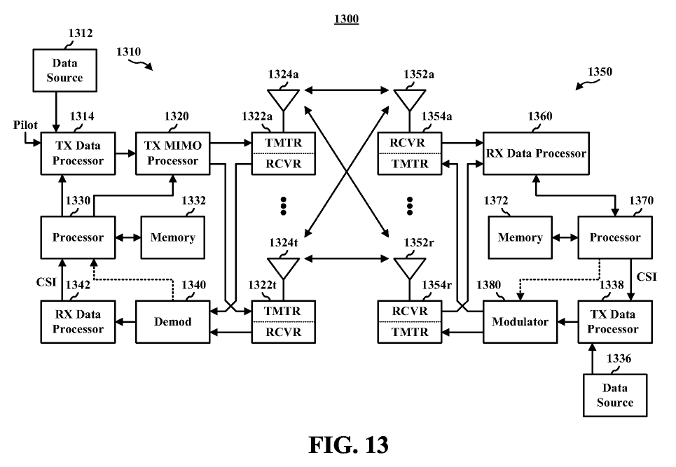

FIG. 13 shows an example wireless communication system 1300. The wireless communication system 1300 depicts one base station 1310 and one mobile device 1350 for sake of brevity. However, it is to be appreciated that system 1300 can include more than one base station and/or more than one mobile device, wherein additional base stations and/or mobile devices can be substantially similar or different from example base station 1310 and mobile device 1350 described below. In addition, it is to be appreciated that base station 1310 and/or mobile device 1350 can employ the systems (FIGS. 1-7 and 11-12) and/or methods (FIGS. 8-10) described herein to facilitate wireless communication there between.

At base station 1310, traffic data for a number of data streams is provided from a data source 1312 to a transmit (TX) data processor 1314. According to an example, each data stream can be transmitted over a respective antenna. TX data processor 1314 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1350 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1330.

The modulation symbols for the data streams can be provided to a TX MIMO processor 1320, which can further process the modulation symbols (e.g., for OFDM). TX MIMO processor 1320 then provides N_{T} modulation symbol streams to N_{T} transmitters (TMTR) 1322a through 1322t. In various embodiments, TX MIMO processor 1320 applies beamforming weights to the symbols of the data streams and to the antenna from which the symbol is being transmitted.

Each transmitter 1322 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1322a through 1322t are transmitted from N_{T} antennas 1324a through 1324t, respectively.

At mobile device 1350, the transmitted modulated signals are received by N_{R} antennas 1352a through 1352r and the received signal from each antenna 1352 is provided to a respective receiver (RCVR) 1354a through 1354r. Each receiver 1354 conditions (e.g., filters, amplifies, and downconverts) a respective signal, digitizes the conditioned signal to provide samples, and further processes the samples to provide a corresponding “received” symbol stream.

An RX data processor 1360 can receive and process the N_{R} received symbol streams from N_{R} receivers 1354 based on a particular receiver processing technique to provide N_{T} “detected” symbol streams. RX data processor 1360 can demodulate, deinterleave, and decode each detected symbol stream to recover the traffic data for the data stream. The processing by RX data processor 1360 is complementary to that performed by TX MIMO processor 1320 and TX data processor 1314 at base station 1310.

A processor 1370 can periodically determine which precoding matrix to utilize as discussed above. Further, processor 1370 can formulate a reverse link message comprising a matrix index portion and a rank value portion.

The reverse link message can comprise various types of information regarding the communication link and/or the received data stream. The reverse link message can be processed by a TX data processor 1338, which also receives traffic data for a number of data streams from a data source 1336, modulated by a modulator 1380, conditioned by transmitters 1354a through 1354r, and transmitted back to base station 1310.

At base station 1310, the modulated signals from mobile device 1350 are received by antennas 1324, conditioned by receivers 1322, demodulated by a demodulator 1340, and processed by a RX data processor 1342 to extract the reverse link message transmitted by mobile device 1350. Further, processor 1330 can process the extracted message to determine which precoding matrix to use for determining the beamforming weights.

Processors 1330 and 1370 can direct (e.g., control, coordinate, manage, etc.) operation at base station 1310 and mobile device 1350, respectively. Respective processors 1330 and 1370 can be associated with memory 1332 and 1372 that store program codes and data. Processors 1330 and 1370 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

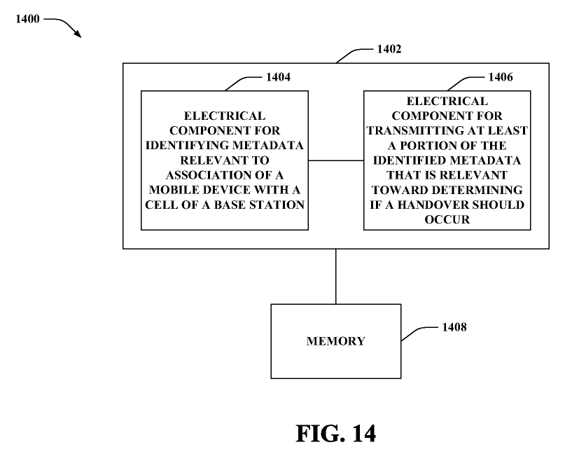

With reference to FIG. 14, illustrated is a system 1400 that effectuates handover management. For example, system 1400 can reside at least partially within a mobile device. It is to be appreciated that system 1400 is represented as including functional blocks, which can be functional blocks that represent functions implemented by a processor, software, or combination thereof (e.g., firmware). System 1400 includes a logical grouping 1402 of electrical components that can act in conjunction. For instance, logical grouping 1402 can include an electrical component for identifying metadata relevant to association of a mobile device with a cell of a base station 1404 and/or an electrical component for outputting at least a portion of the identified metadata 1404. Additionally, system 1400 can include a memory 1408 that retains instructions for executing functions associated with electrical components 1404 and 1406. While shown as being external to memory 1408, it is to be understood that one or more of electrical components 1404 and 1406 can exist within memory 1408.

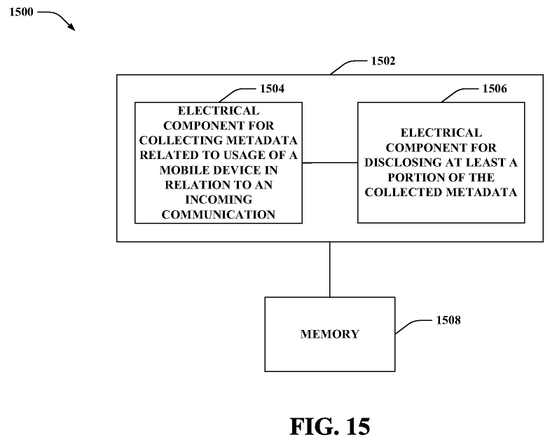

Turning to FIG. 15, illustrated is a system 1500 that manages communication handover. System 1500 can reside within a base station, for instance. As depicted, system 1500 includes functional blocks that can represent functions implemented by a processor, software, or combination thereof (e.g., firmware). System 1500 includes a logical grouping 1502 of electrical components that facilitate controlling forward link transmission. Logical grouping 1502 can include an electrical component for evaluating positioning metadata related to a mobile device 1504. Moreover, the logical grouping 1502 can include an electrical component for determining if the mobile device should transfer from a servicing base station to a neighboring base station, the determination is based at least in part upon a result of the evaluation 1506. Additionally, system 1500 can include a memory 1508 that retains instructions for executing functions associated with electrical components 1504 and 1506. While shown as being external to memory 1508, it is to be understood that electrical components 1504 and 1506 can exist within memory 1508.

The various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Additionally, at least one processor can comprise one or more modules operable to perform one or more of the steps and/or actions described above.

Further, the steps and/or actions of a method or algorithm described in connection with the aspects disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some aspects, the processor and the storage medium can reside in an ASIC. Additionally, the ASIC can reside in a user terminal. In the alternative, the processor and the storage medium can reside as discrete components in a user terminal. Additionally, in some aspects, the steps and/or actions of a method or algorithm can reside as one or any combination or set of codes and/or instructions on a machine readable medium and/or computer readable medium, which can be incorporated into a computer program product.

In one or more aspects, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments can be described or claimed in the singular, the plural is contemplated unless limitation to the singular is explicitly stated. Additionally, all or a portion of any aspect and/or embodiment can be utilized with all or a portion of any other aspect and/or embodiment, unless stated otherwise.

What is claimed is:

1. A method operable upon a wireless communication device for managing handover of a communication, comprising:
identifying metadata relevant to association of a mobile device with a cell of a base station; and
transmitting at least a portion of the identified metadata that is relevant toward determining if a handover should occur, identification or transmission occurs upon the wireless communication device.

2. The method of claim 1, further comprising determining the location of the mobile device, the identified metadata is location of the mobile device, velocity of the mobile device, power level of the mobile device, or a combination thereof.

3. The method of claim 1, further comprising collecting a request for metadata, metadata identification occurs in accordance with the request and transmitting at least a portion of the identified metadata comprises transferring at least a portion of the identified metadata at periodic times.

4. The method of claim 1, further comprising:
setting a level designating a high power output;
measuring a power output of the mobile device; and
determining if the power output is at the high level, upon determining that the output is at the high level metadata identification occurs.

5. An apparatus, comprising:
an identifier that identifies metadata relevant to association of a mobile device with a cell of a base station; and
a transmitter that produces at least a portion of the identified metadata that is relevant toward determining if a handover should occur.

6. The method of claim 5, further comprising an evaluator that determines the location of the mobile device, the identified metadata is location of the mobile device, velocity of the mobile device, power level of the mobile device, or a combination thereof.

7. The method of claim 5, further comprising an obtainer that collects a request for metadata, metadata identification occurs in accordance with the request and production of at least a portion of the identified metadata includes transfer of at least a portion of the identified metadata at periodic times.

8. The method of claim 5, further comprising:
an appraiser that sets a level designating a high power output;
a balancer that measures a power output of the mobile device; and
a resolver that determines if the power output is at the high level, upon determining that the output is at the high level metadata identification occurs.

9. At least one processor configured to manage handover of a communication, comprising:
a first module for identifying detail relevant to association of a mobile device with a cell of a base station; and
a second module for transmitting at least a portion of the identified metadata that is relevant toward determining if a handover should occur.

10. A computer program product, comprising:
a computer-readable medium comprising:
code for causing a computer to identify information relevant to association of a mobile device with a cell of a base station; and
code for causing the computer to transmit at least a portion of the identified metadata that is relevant toward determining if a handover should occur.

11. An apparatus, comprising:
means for identifying metadata relevant to association of a mobile device with a cell of a base station; and
means for transmitting at least a portion of the identified metadata that is relevant toward determining if a handover should occur.

12. A method operable upon a wireless communication device for determining handover of a communication, comprising:
evaluating positioning metadata related to a mobile device; and
determining if the mobile device should transfer from a servicing base station to a neighboring base station, the determination is based at least in part upon a result of the evaluation and the evaluation or determination is performed by the wireless communication device.

13. The method of claim 12, wherein the positioning metadata is location of the mobile device and velocity of the mobile device.

14. The method of claim 12, further comprising:
calculating a freshness level of the positioning metadata; and
establishing if the freshness level is high enough to be relied upon for determining if there should be a mobile device transfer.

15. The method of claim 12, wherein evaluating positioning metadata of a mobile device comprises comparing metadata obtained at different instances.

16. The method of claim 15, wherein determining if the mobile device should transfer from a servicing base station to a neighboring base station comprises resolving if there is a high enough deviation in metadata from the different instances to warrant the transfer.

17. The method of claim 12, further comprising calculating the base station load balancing wherein the determination is based at least in part upon a result of the evaluation and base station load balancing.

18. The method of claim 12, further comprising measuring a power output of the base station wherein the determination is based at least in part upon a result of the evaluation and the power output.

19. An apparatus, comprising:
an analyzer that evaluates positioning metadata related to a mobile device; and
a verifier that determines if the mobile device should transfer from a servicing base station to a neighboring base station, the determination is based at least in part upon a result of the evaluation.

20. The apparatus of claim 19, wherein the positioning metadata is location of the mobile device and velocity of the mobile device.

21. The apparatus of claim 19, further comprising:
a investigator that calculates a freshness level of the positioning metadata; and
a comparator that establishes if the freshness level is high enough to be relied upon for determining if there should be a mobile device transfer.

22. The apparatus of claim 19, wherein the analyzer comprises a distinguisher that compares metadata obtained at different instances.

23. The apparatus of claim 22, wherein the verifier comprises an observer that resolves if there is a high enough deviation in metadata from the different instances to warrant the transfer.

24. The apparatus of claim 19, further comprising a monitor that calculates the base station load balancing the determination is based at least in part upon a result of the evaluation and base station load balancing.

25. The apparatus of claim 19, further comprising an assessor that measures a power output of the base station, the determination is based at least in part upon a result of the evaluation and the power output.

26. At least one processor configured to determine handover of a communication, comprising:
a first module for evaluating positioning metadata related to a mobile device; and
a second module for determining if the mobile device should transfer from a servicing base station to a neighboring base station, the determination is based at least in part upon a result of the evaluation.

27. A computer program product, comprising:
a computer-readable medium comprising:
a first set of codes for causing a computer to evaluate positioning information related to a mobile device; and
a second set of codes for causing the computer to determine if the mobile device should transfer from a servicing base station to a neighboring base station, the determination is based at least in part upon a result of the evaluation.

28. An apparatus, comprising:
means for evaluating positioning metadata related to a mobile device; and
means for determining if the mobile device should transfer from a servicing base station to a neighboring base station, the determination is based at least in part upon a result of the evaluation.
